(19) United States
(12) Patent Application Publication
(10) Pub. No.: US 2009/0317166 A1
(43) Pub. Date: Dec. 24, 2009

(54) MASSAGE AND DISPENSING DEVICE FOR AMONG OTHERS A COSMETIC PRODUCT

(75) Inventor: Gerard GIEUX, Uccle (BE)

Correspondence Address: Dickinson Wright PLLC;James E. Ledbetter, Esq., International Square, 1875 Eye Street, N.W., Suite 1200, Washington, DC, 20006, US

(73) Assignee: FIGIE LUXEMBOURG S.A., Luxembourg (BE)

(21) Appl. No.: 12/145,397

(22) Filed: Jun. 24, 2008

(51) Int. Cl. A46B 11/00; B43K 23/00; B05C 5/00; B43K 5/00

(52) U.S. Cl. 401/28; 401/98; 401/139; 401/137; 401/196

(57) ABSTRACT

The invention relates to a device for dispensing a product, comprising a container (1) for a product, on which there is mounted an application head (3) and a removable protective cap (5) which covers the head (3), the cap (5) comprising a lateral skirt (7) which is substantially in alignment with the walls of the container (1) when the cap (5) covers the application head and which has, at the free end thereof, means for fixing to the container. The device according to the invention is distinguished in that the application head (3) comprises at least one active portion (11) which is fixed to a support and which is orientated in a direction which is inclined relative to the axis of the container and whose dimensions are such that it is completely received in the cap when the cap is fixed to the container.

The present invention relates to a device of the type intended to dispense a product, in particular a cosmetic product, comprising a container for the product, an application head which is mounted on the container and a removable protective cap which is suitable, in a closed position, for covering the head, substantially in continuation of the walls of the container.

Such a device is described in particular in French patent application FR 2 896 963.

At the core of the invention, the Applicant wished to provide such a device with a product application head which also fulfils a massage function, in order particularly to promote the penetration of the product into the skin, for example, by activating the micro-circulation of the blood at point-like locations.

A device for massaging and dispensing a product whose application head comprises a rotating roller which has protrusions is known from document EP-0 779 044. Such an application device has the disadvantage of comprising a limited active surface-area (allowing massage). Furthermore, such a device allows only a back-and-forth movement for carrying out the massage.

An object of the invention is to provide an application head providing the largest possible massage zone and allowing massage movements in all directions.

This object is achieved with a device of the above-mentioned type, which is distinguished in that the application head comprises an active portion which has, when viewed from above, dimensions which are at least equal to the internal cross-section of the cap, and a support to which the active portion is fixed and which is orientated relative to the axis of the container in at least one direction such that the active portion and the support are completely received in the cap in the closed position.

The fact that the active portion has, when viewed from above, dimensions which are at least equal to the cross-section of the cap means that the contour, when viewed from above, of the active portion cannot be inscribed in the cross-section of the cap but not necessarily that, when viewed from above, its surface-area is greater than that cross-section.

When constructed in this manner, the device according to the invention allows the provision of an application head whose active portion has a surface-area larger than would have been provided by an active portion whose axis would be aligned with the axis of the container. Furthermore, since the active portion is fixed to a support, it allows use in all directions, unlike a head which is mounted rotatably relative to the support as in document EP 0779044, wherein the roller allows massage only in one direction. Furthermore, an application head according to the invention is completely protected by the cap which is fixed to the container when the device is not being used, thereby ensuring the quality of the device in terms of hygiene and solidity. Finally, an application head according to the invention allows use of the containers and caps of existing devices, which limits the production costs of the device according to the invention.

The invention may also comprise the following features, taken individually or together:
the active portion of the head is orientated in accordance with a plane parallel with a straight line which passes through two points of the container and which belongs to the same plane of section, those two points being the ones which are furthest away from each other among all the points of the container belonging to the same plane of section,
the active portion is orientated in accordance with an angle between approximately 5° and 90° relative to the axis of the container,
the application head comprises means for opening and closing a passage for conveying the product from the container towards the active portion,
the active portion is mounted so as to be removable on the support of the application head,
the active portion has a shape which is rotationally symmetrical about the axis thereof,
the active portion comprises a foam sponge,
the active portion comprises means for receiving and concentrating the dispensed product to be applied,
the receiving and concentrating means comprise at least one recess which is provided in the wall of the active portion of the application head,
the active portion comprises massage means,
the massage means comprise flexible fingers which are orientated in a direction which is substantially perpendicular relative to the surface of the active portion of the application head,
the massage means comprise flexible petals which are arranged in concentric circles around an opening for dispensing the product arranged in the active portion of the application head,
the support of the active portion of the application head is mounted so as to pivot on a base for fixing the head to the container,
the support of the active portion is mounted so as to pivot about an axis which is substantially perpendicular relative to the axis of the container and the active portion can be orientated in a direction whose angle is substantially between 20° and 330° about the axis.

The invention will be better understood from the description of embodiments which will be set out below with reference to the appended Figures, in which:

FIG. 1 is a front view of a device according to the invention in accordance with a first embodiment,

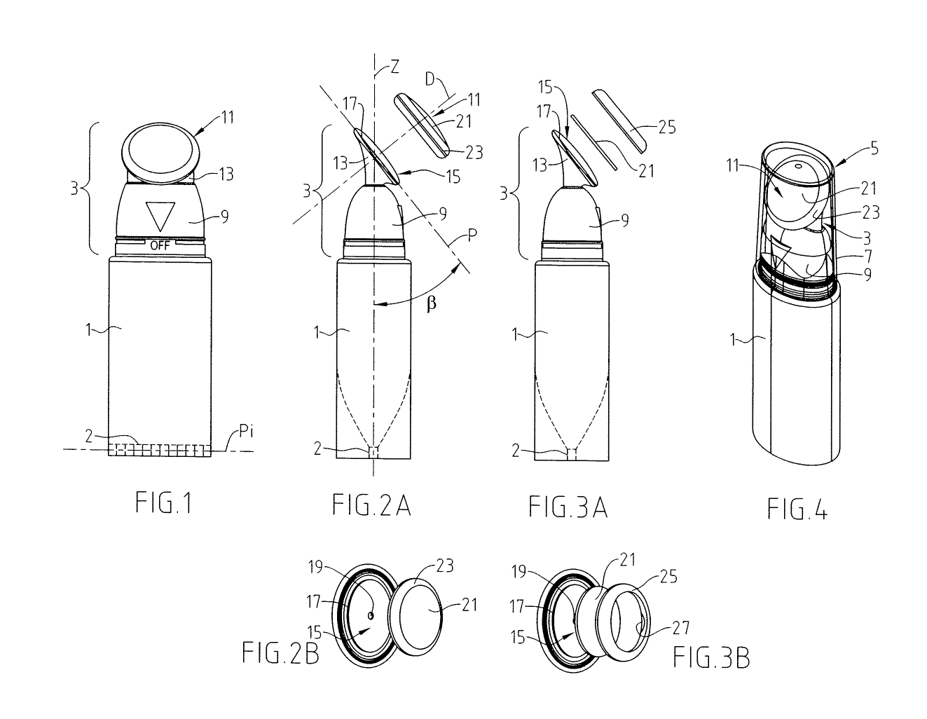

FIG. 2A is a partially exploded side view of the device illustrated in FIG. 1,

FIG. 2B is a partially exploded top view of the device illustrated in FIG. 2A,

FIG. 3A is a partially exploded side view of a device according to the invention in accordance with a second embodiment,

FIG. 3B is a partially exploded top view of the device illustrated in FIG. 3A,

FIG. 4 is a perspective view of the device illustrated in FIG. 1 provided with a cap,

FIG. 5 is a partial front view of a device according to the invention in accordance with a third embodiment,

FIG. 6 is a partial top view of the device illustrated in FIG. 5,

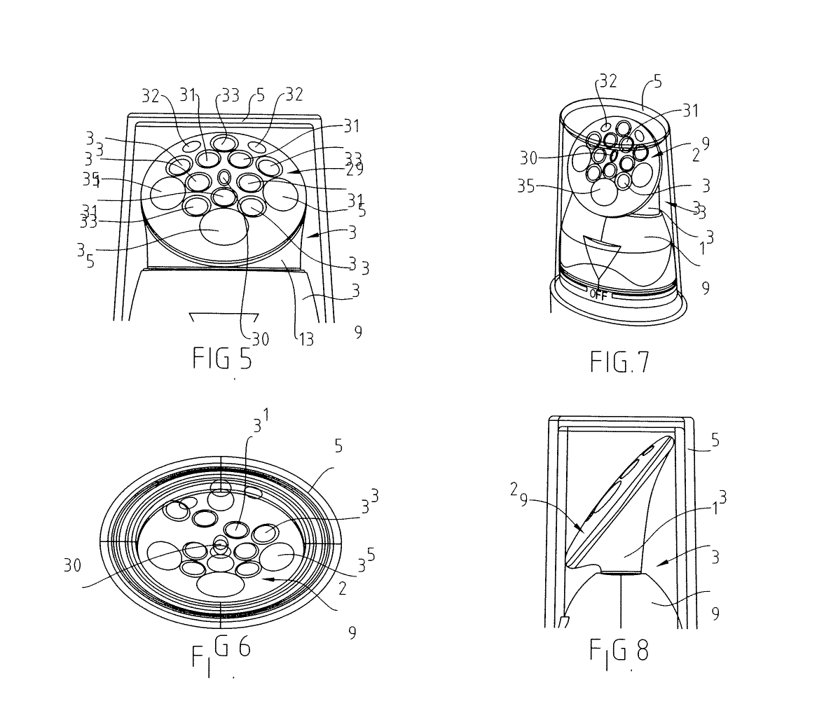

FIG. 7 is a partial perspective view of the device illustrated in FIG. 5,

FIG. 8 is a partial side elevation view of the device illustrated in FIG. 5,

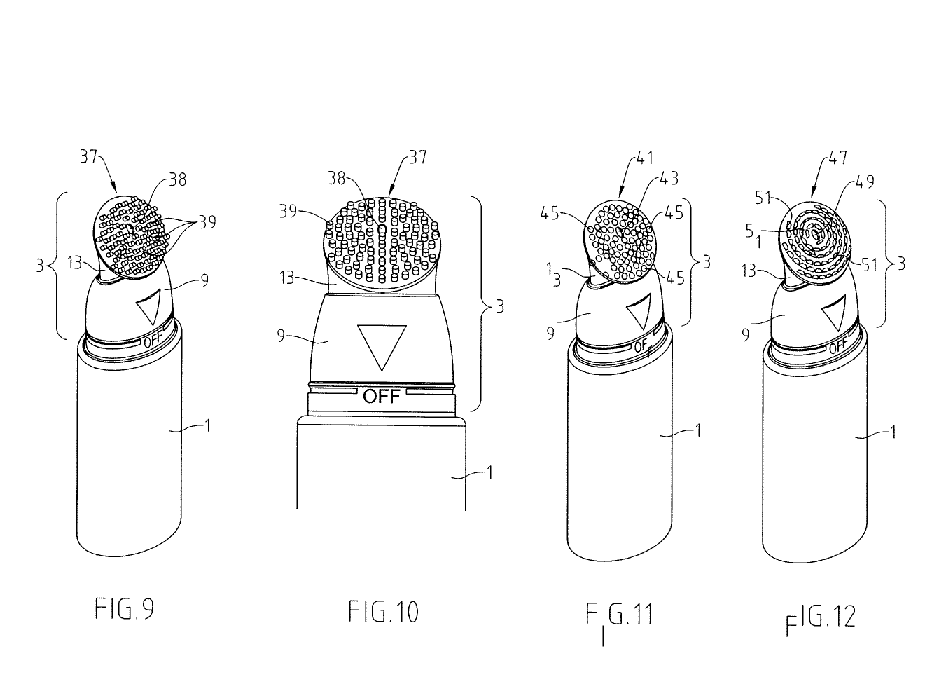

FIG. 9 is a perspective view of a device according to the invention in accordance with a fourth embodiment,

FIG. 10 is a partial front view of the device illustrated in FIG. 9,

FIG. 11 is a perspective view of a device according to the invention in accordance with a fifth embodiment,

FIG. 12 is a perspective view of a device according to the invention in accordance with a sixth embodiment,

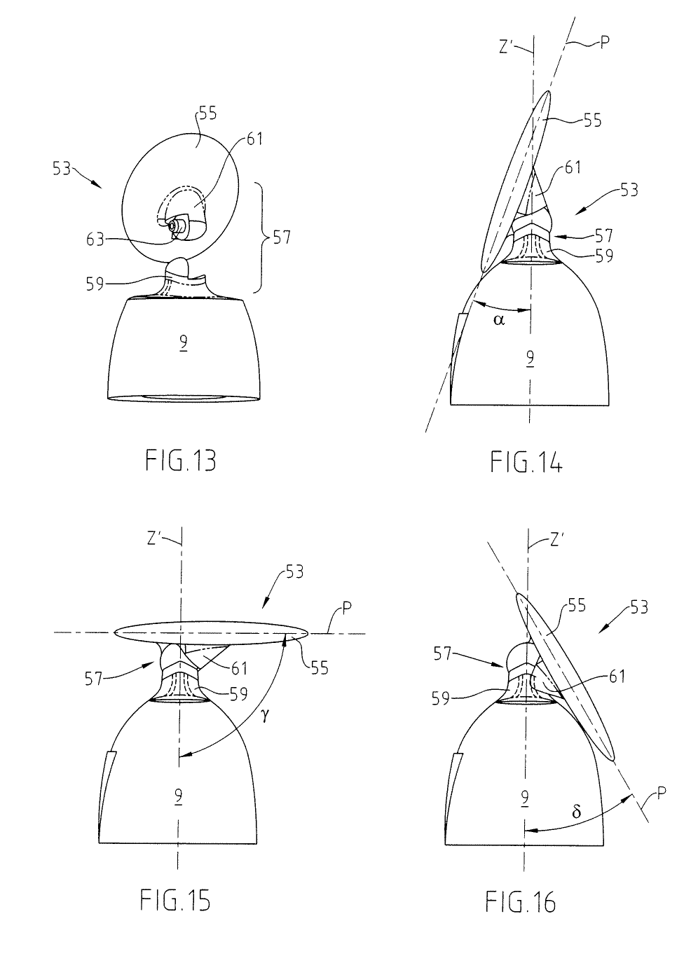

FIG. 13 is a profile view of an application head according to a seventh embodiment, the active portion of which is removed from a base allowing it to be fixed to a container,

FIG. 14 is a side view of the application head illustrated in FIG. 13, with the active portion mounted so as to pivot on the base, the active portion being illustrated in accordance with a first position,

FIG. 15 is a side view of the application head illustrated in FIG. 13, with the active portion mounted so as to pivot on the base, the active portion being illustrated in accordance with a second position,

and FIG. 16 is a side view of the application head illustrated in FIG. 13, with the active portion mounted so as to pivot on the base, the active portion being illustrated in accordance with a third position.

The devices according to the invention illustrated in FIGS. 1 to 4 are intended, for example, to apply a foaming cosmetic product to the skin. It must be understood that this specific application is in no way limiting for the device according to the invention, and that devices such as those described in FIGS. 1 to 4 could also be intended for other applications, such as, for example, the application of a sun care product, a cream, a make-up foundation, in fluid or powder form, fluid gel or talcum powders, or any other product which is capable of being applied to the skin.

The device illustrated in FIG. 1 comprises a container 1 for a cosmetic product, and an application head 3.

The container 1 is a tube which is constructed from flexible plastics material. It is filled via the bottom and it is then closed by crimping 2 the end of the tube in a manner known per se to the person skilled in the art.

As is visible in FIG. 1, the crimping 2 (illustrated with broken lines) is carried out in accordance with a crimping axis Pi which is substantially perpendicular relative to the axis of the container Z illustrated in FIG. 2A.

In FIGS. 2A and 3A, the broken lines illustrate the shape which the container takes up when its end has the crimping 2 allowing it to be closed in a tight manner once filled.

The device also comprises a removable protective cap 5 which is illustrated in particular in FIG. 4 and which covers the application head 3.

The cap 5 comprises a lateral skirt 7 which is substantially in alignment with the walls of the container 1 when the cap 5 covers the application head 3.

In a manner known to the person skilled in the art, the cap 5 comprises an upper wall whose edge is fixedly joined to one of the ends of the lateral skirt 7, with the other end of the lateral skirt, that is to say, the free end, having means for fixing to the container 4.

The application head 3 comprises a base 9 which is fixed to the end of the container 1 and which comprises means for opening and closing a passage for conveying the product from the container 1 towards an active portion 11 of the head (which portion is used to apply the product and to massage). Such a base 9 is particularly described in patent application FR 2 896 963.

The active portion 11 of the application head is fixed relative to the container. To this end, the application head comprises a foot 13 which is connected to the base 9 and through which the passage for conveying the product (which is not illustrated in the Figures) extends.

The end of the foot 13 opposite the base substantially forms a flattened portion 15 which forms a support for the active portion and which is orientated in accordance with a direction D forming an angle β substantially between 5° and 90° with the axis Z of the container. In the context of this embodiment, the direction D forms an angle of substantially 45° with the axis Z of the container.

The active portion 11 is further orientated in accordance with a plane P which is substantially parallel with the crimping axis Pi. The plane P is also parallel with a straight line which passes through two points of the container belonging to the same cross-section, the two points being those which are furthest apart. In the context of this embodiment, the container has an oval cross-section and the two points correspond to the ends of the largest axis of the oval cross-section. In this manner, the active portion has an application surface-area for a product which can be substantially as wide as the widest portion of the container 1, located near the portion in which the application head is fixed.

The active portion 11 of the application head is fixed to the flattened portion 15 so that it is itself orientated in a direction D which is inclined relative to the axis Z of the container.

The inclination is further sufficient for the active portion 11 to be received in the cap which is fixed to the container 1.

To this end, the active portion 11 also has dimensions such that its edge does not abut against the internal walls of the cap 5 in order to particularly facilitate the introduction thereof (see in particular the embodiment shown in FIG. 8).

The flattened portion 15 has a circular contour 17, to which the active portion 11 is fixed. It also has an opening 19, in which the passage for conveying the product which is provided in the application head opens.

The active portion comprises a foam disc 21, the edges of which are fixed in a ring 23 by means of adhesive-bonding or by crimping, securing, welding (hot, ultra-sound, high-frequency welding) or by retention by means of grips.

However, it must be understood that the foam sponge could be fixed by any equivalent means or any other fixing means, such as, for example, hook and loop means which are known by the name VELCRO®.

The ring 23 is fixed to the contour 17 of the flattened portion 15 by snap-fitting.

According to this embodiment, illustrated in FIGS. 1, 2A, 2B and 4, the device is used to apply a cosmetic product to skin, for example, in order to clean it, hydrate it or apply make-up to it. The product is dispensed in the application head by applying pressure to the container and flows onto the foam sponge 21 through the opening 19.

A construction variant is illustrated in FIGS. 3A and 3B.

The foam sponge 21 is not fixed to the edge of a ring 23 by adhesive-bonding, but is instead retained on the flattened portion 15 by a removable ring 25 which is fixed to the contour 17 of the flattened portion by clip-fitting by means of deformable protuberances 27 which are internal with respect to the ring (FIG. 3B), or any lug that the person skilled in the art is able to construct. It must be understood that the clip-fitting could be replaced by any other retention means allowing the foam sponge 21 to be retained.

According to such an embodiment, the active portion is thereby able to be removed, which makes it possible to change the foam sponge 21 when it is worn, for example.

The foam sponge 21 is a simple foam disc so that it is inexpensive to produce (at the very least cheaper than preformed foam sponges).

The foam sponge 21 may be constructed, for example, from flocculent polyurethane, cotton, polyamide fabric, a material produced on the basis of NBR or SBR latex (“Nitrile Butadiene Rubber” and “Styrene Butadiene Rubber”) or any other porous material which is capable of allowing a fluid or a powder to pass through it.

To this end, the active portion has been constructed so as to be round, therefore with rotational symmetry, so as to facilitate the foam sponge being changed by the user who does not have to take care to orientate the foam sponge in a given direction.

Reference will now be made to FIGS. 5 to 8, illustrating a device according to the invention in accordance with a third embodiment.

According to this embodiment, the device is intended for the application of a cosmetic product.

The device comprises a container 1, a base 9 and a foot 13 for an application head 29 and a cap 5 which are identical to those of the two devices described previously.

The application head 29 has an active portion which is of curved lenticular form.

The application head 29 can be constructed in one piece or as a plurality of components which can be assembled. In the context of the embodiment set out, it is constructed in one piece. It may be constructed, for example, from polypropylene, polyamide, polyoxymethylene, polyvinyl chloride, polyethylene terephthalate, or any other material which is sufficiently rigid to withstand pressure applied during the application of a product to the skin with the application head 27, but without being modified in contact with the product to be applied.

The lenticular member comprises an opening 30 which allows the cosmetic product to be dispensed. The opening 30 is constructed so as to be substantially eccentric.

The curved lenticular member comprises means for receiving and concentrating the cream which is dispensed by the application head in point-like zones.

Those means particularly allow “retrieval” of the cream which is not absorbed by the skin, and which would tend to escape towards the edges of the lenticular member during application when the lenticular member is pressed on the skin, and to retain the cream between the lenticular member and the skin.

The receiving and concentration means are constructed by recesses 31, 32, 33 and 35 which are provided in the wall of the lenticular member and which are distributed substantially over the entire surface of the lenticular member.

The recesses 31, 32, 33 and 35 could be constructed so as to be identical, that is to say, having the same shapes and the same dimensions.

In the context of the embodiment which is being described, the recesses are constructed so as to be of different shapes.

They also have different depths. Generally, it is provided that the depth of the recesses is between 0.1 and 1 mm.

In the specific context of this embodiment, the recesses 31, 33 and 35 have round cross-sections and the recesses 32 have ovoidal cross-sections.

The recesses 31, 32, 33 and 35 further have different dimensions: as may be observed in FIGS. 5 to 7, the recesses 31, 33 and 35 have a diameter which increases from the centre of the lenticular member 29 towards the edge thereof.

The recesses 31, 32, 33 and 35 further have different depths: the recesses 31 have a depth of 0.5 mm, the recesses 33 have a depth of 0.9 mm and the recesses 35 and 32 have a depth of 0.1 mm.

Such differences in depth allow the cream near the centre of the lenticular member 29 to be further concentrated, and more particularly in a zone in which the lenticular member is applied to the skin to a greater extent.

The dimensions and depths of the recesses may vary in accordance with the type of product to be applied, in particular in accordance with its viscosity.

The FIGS. 9 to 12 further show other embodiments of an application head 3 of the device according to the invention.

These application heads particularly comprise active portions which are intended for massage in addition to the application of a cosmetic product.

The devices illustrated in FIGS. 9 to 12 are constructed in a manner substantially identical to those of the embodiments set out above, but they have active portions of the application head which are different in accordance with the types of massage for which they are intended.

The application head illustrated in FIGS. 9 and 10 comprises an active portion 37 which is constructed in the form of a curved lenticular member whose edges are clip-fitted to the circular contour of the flattened portion 15 of the foot 13. It must be understood that this embodiment is not limiting and that the head could be constructed in a single piece by means of moulding.

The curved lenticular member 37 has an opening 38 which is provided through the wall thereof, the opening 38 being constructed so as to be substantially eccentric.

Flexible massaging fingers 39 of cylindrical shape have a flat or rounded end and project from the surface of the lenticular member. The fingers 39 are substantially uniformly distributed over the entire surface of the lenticular member 37.

The flexible fingers 39 may be constructed from silicone, for example, from SEBS (Styrene Ethylene Butylene Styrene), EPDM (Ethylene Propylene Diene Monomer), polyurethane, flexible PVC or any other flexible material which is acceptable and known to the person skilled in the art for applying a cosmetic product or hygiene product.

The flexible fingers 39 may be constructed by over-moulding on the lenticular member 37, or by jointly injection-moulding the material, or by assembly.

The flexible fingers 39 have a diameter which is substantially from 1 to 3 mm and a height substantially from 1 to 5 mm.

As is apparent in FIG. 10, the flexible fingers 39 extend in a direction which is substantially perpendicular to the surface of the lenticular member 37 of the application head.

This embodiment allows a massage to be carried out with the same vigour in all directions, the flexible fingers bending in the direction of movement given to the application head.

The application head illustrated in FIG. 11 allows a gentler massage to be carried out.

It has an active portion in the form of a curved lenticular member 41 which has an opening 43 for dispensing a product.

The lenticular member 41 comprises, on its surface, projecting elements 45 which each have a substantially dome-like shape.

The domes 45 are constructed integrally with the lenticular member 41 of the application head. They may be flexible or rigid.

In the context of the embodiment set out, the domes 45 are constructed so as to be rigid in order to allow a gentle massage and to scrape the skin gently.

The domes 45 are constructed so as to be substantially identical and are distributed uniformly over the entire surface of the lenticular member 41.

They have a diameter which is substantially from 1 to 8 mm and a height which is substantially from 0.3 to 5 mm.

The application head of the device illustrated in FIG. 12 allows a more energetic massage than the one obtained with the application heads of FIGS. 9 to 11.

The application head has an active portion in the form of a lenticular member 47, having an eccentric through-hole 49 which allows a cosmetic product to be applied to skin to be dispensed.

The lenticular member 47 has projecting elements which are constructed in the form of petals 51 and which are arranged in concentric circles around the opening 49.

The petals are half-discs which are fixedly joined, by the planar portion thereof, to the surface of the lenticular member 47 in a direction which is tangential relative to a concentric circle.

The petals 51 may be constructed so as to be flexible, for example, from silicone, SEBS (Styrene Ethylene Butylene Styrene), EPDM (Ethylene Propylene Diene Monomer), polyurethane, flexible PVC, or so as to be rigid, from materials such as those set out above from which the application head may be constructed.

The flexible petals 51 can be over-moulded on the lenticular member 37 but are preferably constructed in one piece with the active portion in the form of a lenticular member 47.

Such a lenticular member 47 allows more energetic massage than that achieved by the lenticular members 37 and 41 because the petals which are arranged in circles systematically act counter to the movement that the user confers on the application head in all directions.

Reference will now be made to FIGS. 13 to 16, illustrating another embodiment, according to which an application head 53 and more particularly the support of its active portion is mounted so as to pivot in order to orientate the active portion according to the wishes of the user.

FIGS. 13 to 16 illustrate only an application head 53 comprising a base 9 allowing the head 53 to be fixed to a container, and an active portion 55.

The active portion 55 is substantially planar or, at the very least, of lenticular form, and is inscribed in a plane P illustrated schematically in FIGS. 14, 15 and 16.

The active portion 55 is connected to the base 9 by means of an articulated foot 57.

The articulated foot 57 comprises two elements.

A first foot element 59 is fixed to the base 9.

A second foot element 61, to which the active portion 55 is fixed and which forms a support therefor, is mounted so as to pivot on the first foot element 59.

To this end, the second foot element forming a support comprises an arm 63 which is mounted so as to rotate freely in a blind recess of cylindrical shape (not illustrated) which is provided in the first foot element 59.

The arm 63 is orientated in a direction which is substantially perpendicular relative to the axis Z′ of the application head 53, the axis Z′ being aligned with the axis Z of the container when the application head 53 is fixed thereto.

The arm 63 comprises, at its centre, a channel for supplying (or conveying) a cosmetic product, in accordance with an axis which is perpendicular relative to the axis Z. This channel is in communication with another channel in the same component, having an axis which is perpendicular relative to the plane P, opening at the application surface. Once mounted, this channel communicates with the channel for conveying the product, constructed in the foot 59 of the base 9.

FIG. 14 shows the active portion of the application head in accordance with a first position, referred to as the “cap closure” position. When the active portion of the head is orientated in accordance with this position, the protective cap 5 can be positioned on the application head and can close the device.

In this closure position, the plane P in which the active portion of the application head is inscribed is orientated in accordance with an angle α of substantially 20° relative to the axis Z′ of the application head 53 (or relative to the axis Z of the container when the head 53 is fixed thereto).

FIG. 15 shows a second position which the active portion 53 which is mounted so as to pivot on the base 9 can take up.

In accordance with that second position, the active portion 53 is substantially inscribed in a plane which is orientated in accordance with a direction substantially forming a right-angle γ with the axis Z′ of the application head 53 (or relative to the axis Z of the container when the head 53 is fixed thereto).

Finally, FIG. 16 shows a position referred to as the “extreme” position, in accordance with which the active portion 55 of the application head can be arranged. In accordance with that last extreme position, the plane P in which the active portion 53 is substantially inscribed forms an angle δ of substantially 30° with the axis Z′ of the head 53.

In this manner, as may be understood from the preceding description, owing to the articulated foot 57, the active portion 55 of the head 53 can be orientated in all directions included in a circular arc having, as a centre, the axis of rotation of the arm 63 and, as limits, firstly a first angle of substantially 20° which is formed between the plane P and the axis Z′, in the position of the active portion referred to as the “cap closure” position, and secondly an angle of substantially 30° with the axis Z′ in the position of the active portion referred to as the “extreme” position.

In other words, the active portion 55 of the application head 53 can rotate freely through an angle of 310° about the axis of rotation of the arm 63 and may be orientated in all directions between the so-called “cap closure” position and “extreme” position.

It is evident from the above that the inclination of the active portion of the application head relative to the axis of the container constitutes a particularly ergonomic solution for applying a product to skin. This inclination further allows a surface having good dimensions to be maintained at the active portion, whilst allowing it to be accommodated in the cap. By way of example, in the context of an active portion and a cap cross-section which are circular, the diameter of the active portion may be greater than the diameter of the cap in the ratio V2 for an inclination at 45°.

With regard to the preceding description, it must be understood that the device can be constructed in such a manner that the application heads, or at least the active portions, are interchangeable without, however, departing from the scope of the invention.

It must also be understood that the invention is not limited to the embodiments specifically described. In particular, the container could be constructed differently, for example, with a round cross-section, a square cross-section, from rigid material, in a shape different from that of a tube crimped at one end.

The rigid material could, for example, comprise high-density polyethylene or low-density polyethylene, polypropylene, polyethylene terephthalate, polyvinyl chloride, polyamide, glass, aluminium, iron, steel or even an assembly of a plurality of layers of different materials without this list being exhaustive.

1. A device for dispensing a product, comprising a container (1) for the product, an application head (3) which is mounted on the container (1) and a removable protective cap (5) which is suitable, in a closed position, for covering the head (3), substantially in continuation of the walls of the container (1),
wherein the application head (3) comprises an active portion (11;29;37;41;47) which has, when viewed from above, dimensions which are at least equal to the internal cross-section of the cap, and a support to which the active portion is fixed and which is orientated relative to the axis of the container in at least one direction (D) such that the active portion and the support are completely received in the cap in the closed position.

2. A device according to claim 1, wherein the active portion of the head is orientated in accordance with a plane parallel with a straight line which passes through two points of the container and which belongs to the same plane of section, those two points being the ones which are furthest away from each other among all the points of the container belonging to the same plane of section.

3. A device according to claim 1, wherein the active portion (11;29;37;41;47) is orientated in accordance with an angle between 5° and 90° relative to the axis (Z) of the container.

4. A device according to claim 1, wherein the application head (3) comprises means for opening and closing a passage for conveying the product from the container towards the active portion (11;29;37;41;47).

5. A device according to claim 1, wherein the active portion (11;29;37;41;47) is mounted so as to be removable on the support of the application head (3).

6. A device according to claim 5, wherein the active portion (11;29;37;41;47) has a shape which is rotationally symmetrical about the axis thereof.

7. A device according to claim 1, wherein the active portion (11) comprises a foam sponge (21).

8. A device according to claim 1, wherein the active portion (29) comprises means (31;32;33;35) for receiving and concentrating the dispensed product to be applied.

9. A device according to claim 8, wherein the receiving and concentrating means (31;32;33;35) comprise at least one recess which is provided in the wall of the active portion of the application head.

10. A device according to claim 1, wherein the active portion (37;41;47) comprises massage means.

11. A device according to claim 10, wherein the massage means comprise flexible fingers which are orientated in a direction which is substantially perpendicular relative to the surface of the active portion (37) of the application head (3).

12. A device according to claim 10, wherein the massage means comprise flexible petals which are arranged in concentric circles around an opening (49) for dispensing the product arranged in the active portion (47) of the application head (3).

13. A device according to claim 1, wherein the support of the active portion of the application head is mounted so as to pivot on a base for fixing the head to the container.

14. A device according to claim 13, wherein the support of the active portion is mounted so as to pivot about an axis which is substantially perpendicular relative to the axis of the container and in that the active portion can be orientated in a direction whose angle is substantially between 20° and 330° about the axis.

15. A device according to claim 2, wherein the active portion (11;29;37;41;47) is orientated in accordance with an angle between 5° and 90° relative to the axis (Z) of the container.

16. A device according to claim 2, wherein the application head (3) comprises means for opening and closing a passage for conveying the product from the container towards the active portion (11;29;37;41;47).

17. A device according to claim 3, wherein the application head (3) comprises means for opening and closing a passage for conveying the product from the container towards the active portion (11;29;37;41;47).

18. A device according to claim 15, wherein the application head (3) comprises means for opening and closing a passage for conveying the product from the container towards the active portion (11;29;37;41;47).

19. A device according to claim 2, wherein the active portion (11;29;37;41;47) is mounted so as to be removable on the support of the application head (3).

20. A device according to claim 3, wherein the active portion (11;29;37;41;47) is mounted so as to be removable on the support of the application head (3).
